(19) United States
(12) Patent Application Publication
(10) Pub. No.: US 2013/0233043 A1
(43) Pub. Date: Sep. 12, 2013

(54) METHOD AND APPARATUS FOR ESTABLISHING CALIBRATION CYCLES BASED ON ACTUAL TOOL USE FOR TOOLING AND INSTRUMENTS REQUIRING PERIODIC CALIBRATION

(71) Applicant: DANIELS MANUFACTURING CORPORATION, Orlando, FL (US)

(72) Inventor: William D. Kelly, Orlando, FL (US)

(73) Assignee: DANIELS MANUFACTURING CORPORATION, Orlando, FL (US)

(21) Appl. No.: 13/727,096

(22) Filed: Dec. 26, 2012

Related U.S. Application Data
(60) Provisional application No. 61/590,550, filed on Jan. 25, 2012.

(51) Int. Cl. G01B 21/16

(52) U.S. Cl. CPC G01B 21/16
USPC 73/1.01

(57) ABSTRACT

A method and apparatus for verifying calibration of a tool used in a repetitive applications, the tool having at least one part that moves with respect to another part of the tool during each repetitive application. An electronic sensor and a microcontroller operatively coupled to the tool detects and counts each repetitive application. A motion sensor provides an indication to the microcontroller of each repetitive application. The microcontroller stores a continuous count of the number of repetitive applications and compares that count to a predetermined maximum number of counts allowed during a calibration cycle, and provides a signal indicating when the stored continuous count reaches the predetermined maximum count. The signal may be a local visual indicator and a transmitted signal to a remote location to indicate that the tool is in need of re-calibration.

### SPECIFIC DATA RELATED TO THE INVENTION

This invention claims priority to U.S. Provisional Application No. 61/590,550 tiled Jan. 25, 2012 which is incorporated herein by reference.

The present invention relates to a method and apparatus for measuring actual tool use for critical tooling such as electrical terminal crimp tools for aircraft wiring connections and, more particularly, to a method and apparatus for tracking actual use of the tooling so as to assure that the tools are not used beyond a predetermined number of tool cycles.

### BACKGROUND OF THE INVENTION

Connectors used in high reliability wiring systems generally comply with specifications or standards which require contacts that utilize a plurality of male and female pins and sockets in opposite ends of a mating connector pair to complete electrical connections between wire leads or conductors connected to the connector pair. Typically, the pins are small diameter elements that are replaceable in each of the mating connector pairs or similar electrical interconnect device. A typical male pin has an end portion that is generally solid and a rear portion which is hollow and designed to receive a bare or stripped wire of a conductor connected to the pin. Such pins generally require only a single crimp in order to fasten the pin to the conductor.

Other types of end fittings used for terminating conductors in a high reliability wiring system are sockets, terminals, splices, coaxial connectors, triaxial connectors, fiber optic connectors, and ferrule sleeves which have unique hollow barrel configurations requiring uniquely configured crimp tooling which reshapes the termination component to a precise dimension and shape that will hold the conductor, the insulation or covering on the conductor, or the fiber optic elements so the most efficient mechanical and electrical properties will be achieved. in that termination.

Crimp tools for terminating conductors such as electrical wire and fiber optic components have long been in use in high reliability systems. Such long experience has led to the development of standards and measurements to assure that the crimp formed by a tool meets minimum pull tests and environmental requisites, such as for example, moisture exclusion. Based on repeatable measurements and empirical testing, it is known that a tool designed and calibrated to produce the correct crimp on a terminating component-conductor connection has a limited life cycle. En other words, after a certain number of cycles, the crimp formed by the tool will begin to lose its maximum effectiveness due to normal wear and fatigue in the internal components of the tool, or perhaps due to improper use or handling of the tool. At such time, the tool should be taken out of service, and sent for repair or replacement. In general practice, users have established time periods based on expected use of the tool which are manually recorded. in terms of “next calibration date”. During the selected time period between calibrations, the tool is assumed to maintain its calibration. Accordingly, tools are provided with a dated calibration sticker and tracked so that after a fixed time period, the tool is pulled from service and returned to a lab for calibration and a new calibration sticker with the next due date identified on the sticker.

One disadvantage with this type of calibration cycle approach is that the tool may not have been used enough during any time cycle to have lost its calibration. In some instances, the tool may have been placed in a tool stockroom and not even been placed in service during a service interval. In other cases, the tool may have been used to terminate more wires than expectations would have predicted. Accordingly, it is desirable to provide an improved method and apparatus for determining when a tool has reached an end of a calibration interval by the number of termination cycles, rather than the number of days or time since the last inspection. Also, if the tool is dropped or receives stress from rough handling, the tool should be removed from use and tested in the calibration lab to verify that the shock did not change or upset the calibration of the crimp tool.

Under the present manual crimp tool management system of recording dates and calibration or service date for tools in handwritten or manual input charts, the accuracy and completeness of records used to keep track of crimp tools used in production shops is totally operator dependent. It would be desirable to eliminate the requirement for operator tracking of tool use and provide a system that will automatically report to an electronic data base with identifying information programmed into the crimp tool along with a record of use of the tool.

### SUMMARY OF THE INVENTION

The present invention is illustrated in one form in the context of an electrical wiring termination tool that utilizes a cycle counting processor circuit which is incorporated into the tool to provide accessible digital memory of the identity of the tool and the actual number of cycles (each closing and opening of a hand tool, or the activation through a crimp operation in a powered crimp tool) that has occurred. Use of a cycle counter digital memory circuit is unique to the hand-held and powered crimp tool art. Such crimp tools are heavily used in the high reliability equipment industries and in other industries employing multi-pin connectors, terminals, and other terminating devices. Obviously, the wire termination component reliability is much more important in mission critical systems associated with aircraft, spacecraft, medical, and other high reliability system environments since an electrical signal failure may result in failure of the electrical or digital signal systems that could cause drastic consequences.

In one form, the cycle digital memory counter feature uses a magnetically actuated switch to detect closure of a pair of moveable tool handles. Reference may be made to U.S. Pat. No. 7,162,909 assigned to the assignee of the present invention and which describes an exemplary crimp tool in both manual and power operated versions with which the present invention may be used. A magnet may be attached to one of the handles of the manually operated crimp tool and a magnetically actuated switch attached to another of the handles in a location such that closing of the handles brings the switch into proximity of the magnet so that the switch is activated. Tools having no moveable handles, such as a tool powered by compressed air, hydraulic fluid, or an electro-mechanical drive may be fitted with the same magnetic sensor arrangement or an electrical/electronic switch mounted in an internal location which will actuate momentarily once each time the tool performs a work cycle. In an illustrated embodiment, the tool incorporates a minimum of 3 LED lights of different colors (green, red, and amber) to visually indicate different tool status conditions. In this form, the green LED light is turned on momentarily each time the tool switch is activated. The red LED light is activated to indicate that the preset calibration number of cycles has been reached, or the shock sensor has indicated a need to test the tool, and the tool should be removed from use, and sent to the calibration lab. The amber colored LED is activated to indicate a low battery condition. The calibration period in this sense is a fixed number of cycles of the crimp tool that is decided by the user/owner of the tool, and pre-loaded into the associated software/computer using a keyboard/mouse or other means to manipulate digital information. The decision to set a certain number of cycles as the limit is based on known characteristics of the tool, and the judgment/experience of the user/owner. The number of cycles may be established by empirical testing of crimp tools to determine a safe number of cycles before the tool begins to lose its calibration from wear or some other judgment based upon experience with a particular tool,

### BRIEF DESCRIPTION OF THE DRAWINGS

For a better understanding of the present invention, reference may be had to the accompanying drawings in which:

FIGS. 1 and 2 are side and bottom edge views, respectively, of one form of tool with which the present invention may be used;

FIG. 3 is a partial cutaway view of another form of tool incorporating one embodiment of the present invention;

FIGS. 4 and 5 are bottom edge and side views of another form of tool incorporating one embodiment of the present invention;

FIGS. 6 and 7 are a partial cutaway side view and a bottom edge view of a pneumatic tool incorporating one embodiment of the present invention;

FIG. 8 illustrates a hardware block diagram of one embodiment of the present invention; and

FIG. 9 illustrates an exemplary version of a system architecture for implementing the present invention.

### DETAILED DESCRIPTION

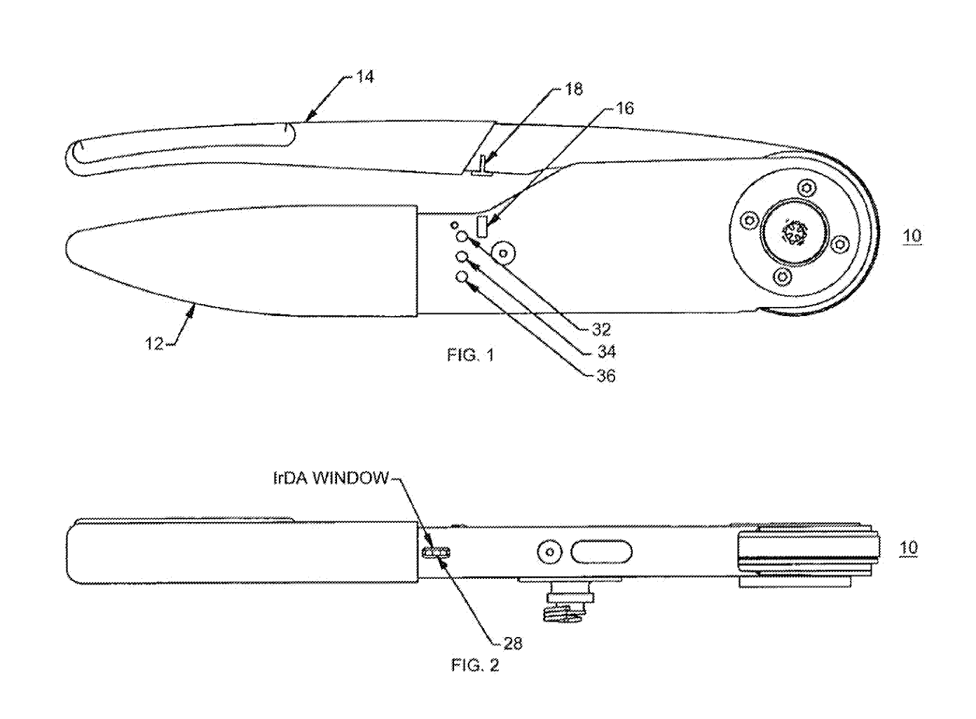

Referring generally to FIGS. 1-5 and beginning with FIGS. 1 and 2, there is shown a side view and a bottom edge view of a typical hand-held crimp tool 10 similar to that shown in the aforementioned U.S. Pat. No. 7,162,909 having a pair of relatively moveable handles 12 and 14. In this embodiment, the tool uses a cycle sensor comprising a magnetic reed switch 16 of a type well known in the art mounted in the handle 12 and a magnet 18 mounted in handle 14. In other tool applications, a micro switch or other type of electronic switch may be used to sense the tool has actuated through a functional duty cycle. While a non-contact type of switch is preferable, the invention could be implemented using a contact type of microswitch. The switch and magnet are mounted in a position such that closing of the handles or actuating the mechanism of a powered tool brings the magnet into proximity with the switch so that the switch is actuated. In the case of a powered tool, there may be a single actuating lever on the tool or there may be a remote activating device such as a foot switch. For such tools, it may be advantageous to mount the cycle sensor within the tool for sensing the movement of a piston used to drive the tool indentors into engagement with the contact terminal, such as, for example, by mounted a switch in juxtaposition to the camming surface described in the aforementioned '909 patent.

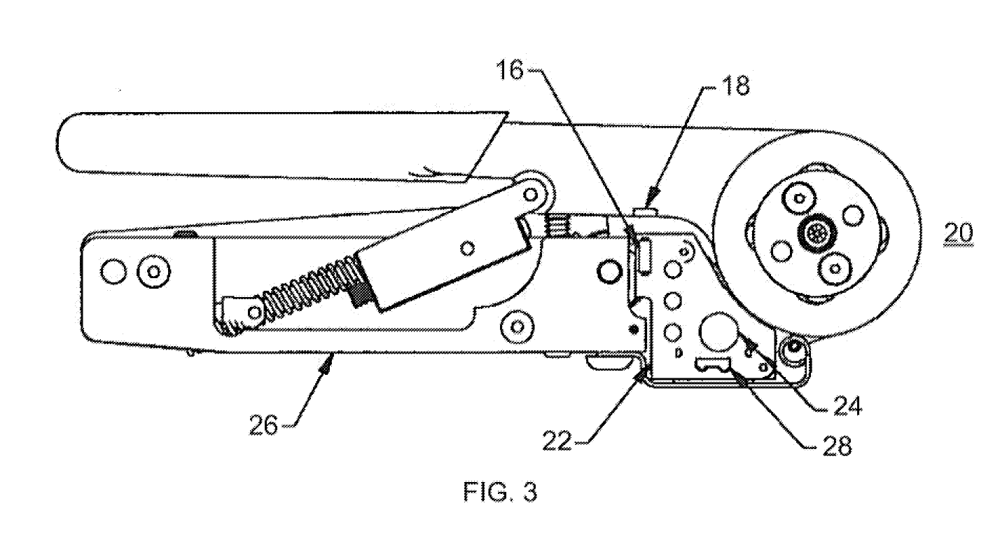

FIG. 3 shows a partial cross-sectional view of a crimp tool 20 similar to tool 10 with a digital counter circuit and associated battery indicated generally at 22, 24 respectively, mounted into or onto a handle 26. The digital counter circuit 22 is incremented each time that the switch 16 is actuated. The battery 24 is placed in a battery holder (not shown) within handle 16 for powering the switch 16 and counter circuit 22. The counter circuit 22 may be any of the commercially available counters that include the electronics responsive to a digital input from a switch for incrementing the counter. The counter may be a simple incrementing counter or include electronics for storing a count in the event of power failure or storing a total count even when the visual counter is reset. The counter may also include remote wireless access to allow remote monitoring of tool use such as by the indicated IRDA module 28.

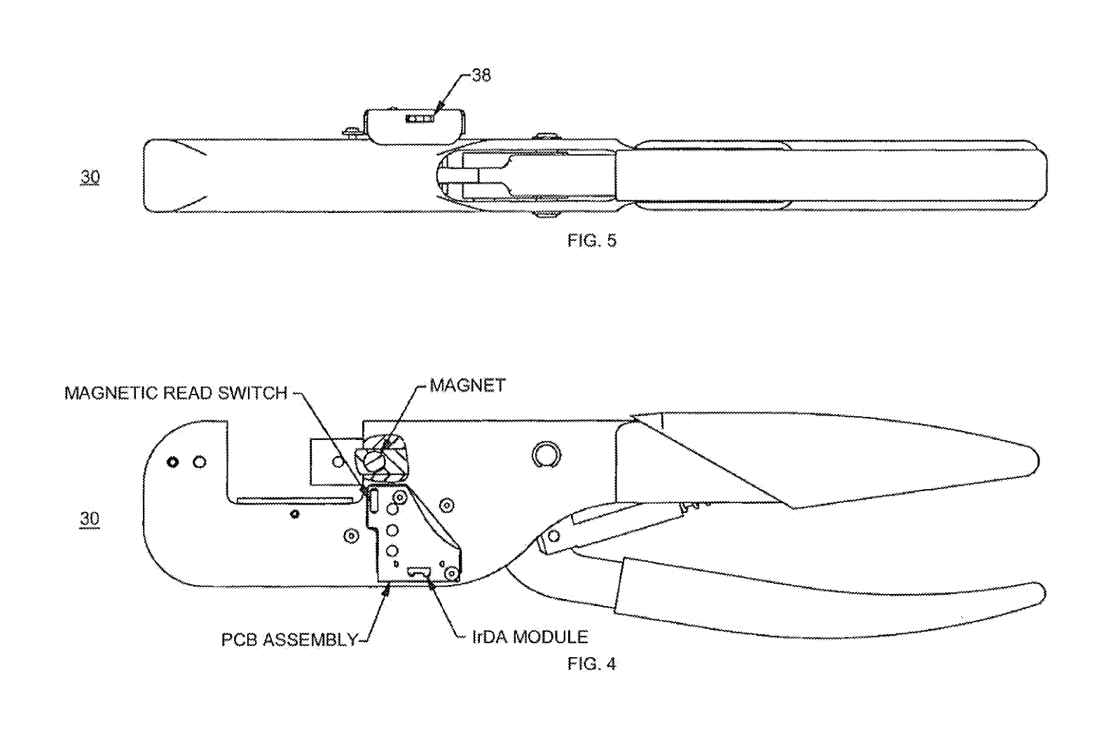

Another type of manual hand held crimp tool 30 is shown in partial cross section in FIG. 4 and in a bottom plan view in FIG. 5. In this tool, the same battery actuated reed switch and electronic package are mounted in different locations, but used in the same way to achieve the same function of counting each cycle of tool operation. In both the tool 10 and tool 30, the status of the tool is indicated by momentarily lighting a green light emitting diode (LED) light 32 that is easily visible to the operator of the tool. When the predetermined number of crimp/closure cycles have been achieved, the internal program (Firmware) will no longer light the Green LED, but instead, will activate a red LED light 34 which indicates to the user that the predetermined number of cycles has been reached, and the tool must be taken out of service for Gauging/Calibration. If the battery falls below an acceptable level for the circuit to work properly or another malfunction occurs, a yellow/amber LED light 36 will activate when the tool is cycled, indicating to the operator that the tool is in need of service. While the battery is below an acceptable power level, or removed from the crimp tool, the nonvolatile memory will hold all date currently in memory, but not acquire new memory/data. In this tool 30, it will be noted that the electronics for the counter circuit and IRDA device are attached to the outside surface of the tool as shown at block 38 in FIG. 5.

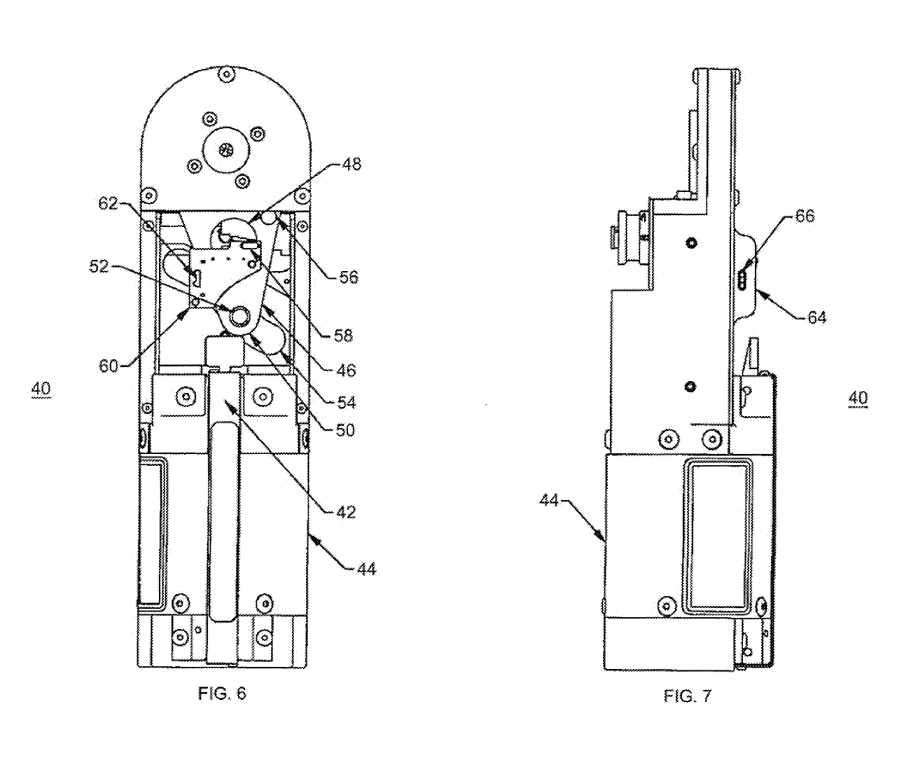

FIGS. 6 and 7 illustrate a pneumatic crimp tool 40 and a mechanism for counting functional duty cycles of the tool. FIG. 6 is a bottom edge view and FIG. 7 is a partial cross-sectional view of the tool, respectively. An example of such a tool is shown in U.S. Pat. No. 7,162,909 and a complete description of tool 40 may be had by reference to the '909 patent. In this example, the tool 40 incorporates a ram 42 that moves linearly within the handle 44 of the tool. Movement of the ram 42 effects partial rotational movement of an arm 46 by virtue of the arm being pinned at axis 48 and having an opposite end 50 attached to a roller 52 that rides in a slot 54. A magnet 56 is fixed to the arm 46 and a magnetic reed switch 58 is mounted in the tool handle 44 such that each cycle of the tool causes the magnet to pass in proximity to the switch and cause it to actuate. As with the first embodiment, actuation of the switch 58 can be used to increment a digital counter memory circuit 60 and illuminate the LED lights as previously described. A transceiver 62 is associated with the circuit 60 to allow for wireless communication with the circuit 60. As shown in FIG. 6, the electronic circuit and transceiver may be mounted to an outer surface of the tool as indicated at 64. A window 66 is provided for IR communication if the device 62 is selected to be an IRDA type transceiver.

In either of the above embodiments, it will be recognized that the counter can be of the type that enables remote access so that the contents of the counter can be read from a calibration lab to assure that the tool is not used beyond its intended calibration period, the period constituting a fixed number of cycles of the tool. More particularly, the counter is implemented in a microcontroller such as those available from Texas Instruments, Inc and other integrated circuit manufacturers that provide microcontrollers having Wi-Fi (IEEE 802.11/WLAN) or Blue Tooth® capability. Such microcontrollers are programmable to provide the functions necessary to count cycles in response to input from a microswitch and to store the count in an on-board memory for remote access. Although a microswitch is discussed as a preferred embodiment, it will be recognized that other techniques could be used to detect movement between two elements of the tool. For example, a Laser detection device could be used to read movement in a manner similar to that used to read Bar Codes. The use of remote reading of tool status can assure that the operator of the tool does not use the tool beyond its intended limits. In lieu of a Wi-Fi connection, the system could also use infrared data association (IrDA), The transceiver is preferably coupled in operative relationship with the microcontroller so that data from the microcontroller identifying not only the number of cycles but also the particular tool associated with the data can be read. Such data may include a tool serial number or other type identifier.

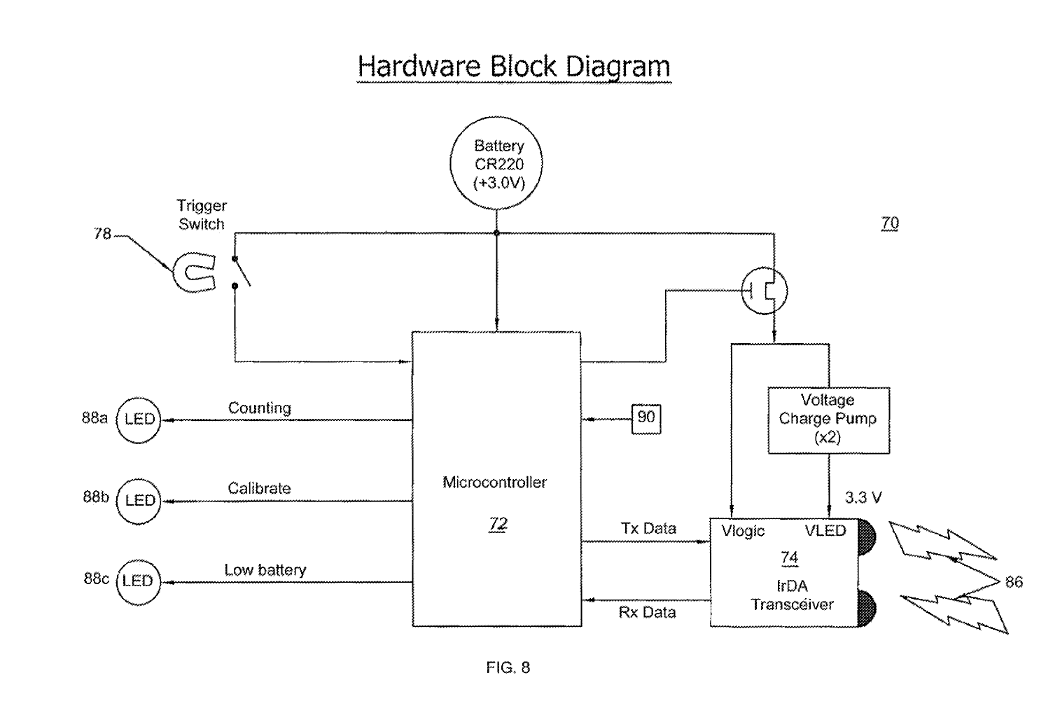

Referring to FIG. 8, there is shown a simplified block diagram of a microcontroller system 70 that can be incorporated into or attached to any tool having relatively moving parts in order to count the number of cycles that the tool experiences. A microcontroller 72 such as a TI type MSP430F2272IRHA and a transceiver 74 such as a Vishay Intertechnology, Inc. type TFBS4652 are the two active components of the system. Count input to the microcontroller 72 is provided by the magnetically actuated switch 76 each time that the magnet 78 passes adjacent the switch. The switch 76 is preferably a Coto Technology, Inc. type CT05-1535-J1. Power for the system is provided by a battery 80 such as a type CR1220. Power is supplied to the transceiver 74 through an electronic switch 82, controlled by the microcontroller 72, and a voltage doubler 84. The transceiver 74 has four base terminals, namely the voltage for logic input from the switch 82, power for the LED's from the voltage doubler 84, and the data input and data output connections with the microcontroller 72. As indicated by the arrows 86, communication with the system 70 in the illustrated embodiment is via infrared transmission. However, the IRDA type transceiver can be replaced by various types of Wi-Fi or other radio technology to allow communication without direct line of sight. It is also possible to use a direct electrical wiring communication technique rather than the illustrated IR or radio communication. The local output from the microcontroller 72 are the three LED activation signals 88a, 88b and 88c for indicating counting, low battery and time for calibration as described above.

FIG. 8 also illustrates an additional sensor 90 for providing a signal to the microcontroller 72 if the tool is subjected to an unusual shock, such as by being dropped onto a floor, which could cause the tool to lose calibration. In this instance, the sensor 90 may be a conventional accelerometer that provides a signal proportional to acceleration, such as, for example, an Analog Devices, Inc type ADXL325BCPZ-RL7 accelerometer. The acceleration signal is detected by the microcontroller and if it exceeds a predetermined threshold level, the microcontroller will activate the out of calibration LED via line 88b. Such an accelerometer can be mounted to the tool in various ways, depending on the type of tool and configuration. In some instances, the accelerometer could be mechanically fastened and in others could be adhesively bonded. In other cases, the accelerometer could be mounted onto the printed circuit board by conventional component mounting methods.

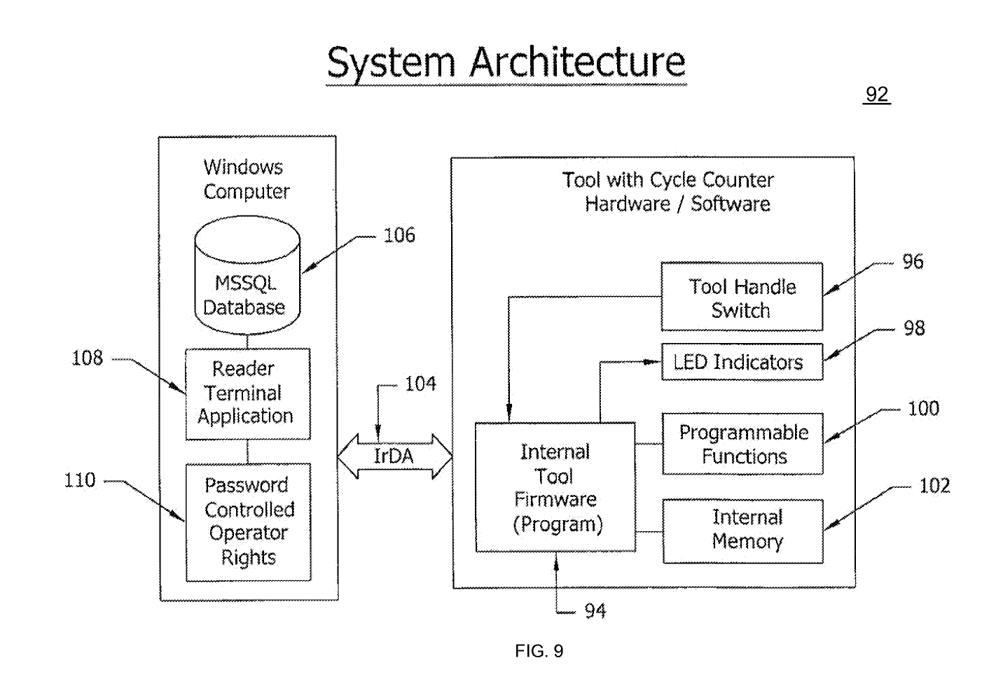

FIG. 9 illustrates one form of system architecture 92 for the system 70 of FIG. 7 and the communication with a remote computer terminal. The system architecture includes the internal tool firmware (block 94) embedded in the microcontroller 72, the signal input from the tool cycle switch (block 96) the LED indicators (block 98), the programmable functions of the microcontroller 72 (block 100) and the microcontroller internal memory (block 102). Bi-directional communication via Wi-Fi or other system is preferably to remote server indicated by block 104. The server includes a database (block 106) of all tools being monitored and a reader terminal application (block 108) that extracts tool data from the database and performs the necessary functions to compare data and determine when the tool is to be re-calibrated. The server preferably includes a password controlled access application to control access (block 110). Software operable in the database is employed to change the microcontroller program through a wireless arrangement utilizing Infrared Data Association (IrDA). The Software embodies a data collection scheme which automatically identifies the coded unit identification numbers in each tool or instrument, displays the information in memory in the tool firmware non-volatile memory, and transfers it to a stored SQL database. The software also provides the user/operator the capability of resetting, and/or reprogramming the tool internal firmware memory/settings.

While the present invention has been described in the context of an electrical terminal crimping tool, it will be recognized that the invention could be applied to other tools or instruments that required periodic calibration in order to assure that the tool or instrument provides consistent pressure or force, or is subject to wear that could affect quality of an end product with which the tool or instrument is used. Such applications could be, by way of example, a torque wrench, a measuring device or a medical instrument. En each such example, the location and operation of the motion sensor or a pressure sensor will vary with the particular type of tool. Accordingly, it is intended that the invention not be limited to the specific illustrated embodiment but be interpreted within the full spirit and scope of the appended claims.

What is claimed is:

1. A method for verifying calibration of a tool used in a repetitive application, the tool having at least one part that moves with respect to another part of the tool during each repetitive application, the method using an electronic sensor and a microcontroller for detecting and counting each repetitive application and comprising:
providing a motion sensor operatively associated with the one part that moves for providing an indication to the microcontroller of a repetitive application of the tool;
programming the microcontroller to store a continuous count of the number of repetitive applications of the tool;
comparing, in the microcontroller, the stored continuous count to a predetermined maximum number of counts allowed during a calibration cycle; and
providing, from the microcontroller, a signal indicating when the stored continuous count reaches the predetermined maximum count.

2. The method of claim I wherein the microcontroller is coupled for controlling a sequence of different color indicator lamps, one of the lamps providing an indication during the time that the stored continuous count is less than the maximum count and another of the lamps providing an indication when the stored count exceeds the maximum count.

3. The method of claim 2 and including the step of actuating a different color lamp to indicate a low battery condition of the microcontroller.

4. The method of claim land including a transceiver operatively coupled to the microcontroller, the transceiver transmitting information identifying the tool and the number of counts to a remote server.

5. The method of claim 4 wherein the transceiver uses infrared data transmission.

6. The method of claim 1 wherein the tool comprises an electrical terminal crimping tool and the motion sensor is positioned to count each time that the tool completes a crimping cycle.

7. The method of claim I and including an accelerometer operatively coupled to the microcontroller for providing a signal indicative of a shock force being applied to the tool.

8. The method of claim 7 wherein the accelerometer is arranged to detect that the tool has been dropped from a level higher than a predetermined minimum level or otherwise subjected to shock of comparable levels.

9. The method of claim 7 and including the step of providing an out of calibration signal upon receipt of a shock force signal from the accelerometer.

10. A method for assuring that a hand-held crimp tool is within a calibration period based on actual usage when used for repetitive crimping of a contact onto electrical signal conductors comprising:
providing a motion sensor operatively mounted to the tool in a location to sense actuation of the tool through a crimping cycle, the sensor providing a cycle signal each time that the tool executes a crimping cycle;
providing an electronic digital counting circuit operatively connected to the motion sensor for receiving the cycle signal and storing data representative of the number of cycles completed by the tool;
establishing a predetermined number of cycles as an indicator that calibration of the tool is required; and
providing, from the counting circuit, a signal to a tool user when the number of counted cycles of the tool reaches the predetermined number of cycles.

11. The method of claim 10 and including a transceiver operatively coupled to the counter circuit and arranged to provide remote access to the data stored in the counter circuit.

12. The method of claim 11 wherein the counter circuit comprises a microcontroller and the transceiver enables remote detection of the identity of the tool for associating the actual usage count with the actual tool being used.

13. The method of claim 12 and including the step of wirelessly communicating tool status to a remote location.

14. The method of claim 13 wherein the transceiver is of a type using infrared data acquisition.

15. The method of claim 10 wherein the motion sensor comprises a magnet mounted to the tool and arranged to come into proximity of a magnetically responsive microswitch when the tool is actuated through a crimp cycle.

16. Apparatus for assuring that a hand-held crimp tool is within a calibration period when used to crimp a contact onto and electrical signal wire comprising:
a magnet mounted to a moveable element of the tool, the moveable element being directly moved my manual or powered manipulation in response to the tool being actuated to crimp a wire termination component onto a wire lead;
a magnetically actuated switch mounted onto another element of the tool, the switch being positioned to be actuated by proximity of the magnet when the moveable element moves into a tool actuation position;
an internal electronic digital memory circuit connected to the switch and adapted to count the number of times the switch is actuated, the apparatus having a digital memory for recording the count and for generating a. first electrical output for every tool cycle less than a predetermined number of tool cycles and for generating a second electrical output for every tool cycle equal to or greater than the predetermined number of tool cycles; and
an LED light system visible to a user of the tool wherein each first electrical output causes actuation of an LED of one color and each second electrical output causes actuation of an LED of another color

17. The apparatus of claim 16 and including an accelerometer mounted to the tool for detecting mechanical shock applied to the tool and for indicating a requirement for tool calibration if the level of mechanical shock exceeds a predetermined level.

18. The apparatus of claim 17 and including a microcontroller mounted in the tool for tracking tool usage and shock events, the microcontroller being operatively associated with a transceiver for communicating tool status to a remote location.

19. The apparatus of claim 18 wherein the microcontroller includes a memory circuit for storing data representative of actual tool use in association with data identifying the tool.

20. The apparatus of claim 19 wherein the microcontroller is remotely programmable via the transceiver for updating data in the memory circuit.
